(19) United States
(12) Patent Application Publication
(10) Pub. No.: US 2015/0207535 A1
(43) Pub. Date: Jul. 23, 2015

(54) MAGNETIC BUTTON PHONE CASE

(71) Applicant: Keith Wilson, Zuni, VA (US)

(72) Inventor: Keith Wilson, Zuni, VA (US)

(21) Appl. No.: 14/674,187

(22) Filed: Mar. 31, 2015

(51) Int. Cl. H04B 1/3888; H01F 7/02

(52) U.S. Cl. CPC H04B 1/3888; H01F 7/02

(57) ABSTRACT

The various embodiments of the present invention disclose a mobile phone holder with magnetic adherence enhancement comprises a ruggedized case, a primary magnetic strip and a mating magnetic strip. The ruggedized case comprises an adjustable chamber on an internal surface. The primary magnetic strip is adhered to a back surface of the mobile phone holder using an adhesive. The mating magnetic strip comprises a rear surface applied with an adhesive. The mating magnetic strip is fixed to a non-metallic surface. The primary magnetic strip is magnetically locked to the mating magnetic strip.

### CROSS-REFERENCE TO RELATED APPLICATION

This application claims priority to U.S. Provisional Application No. 62/072,504. The contents of which are hereby incorporated by reference in its entirety

### BACKGROUND

1. Technical Field of Invention

The present invention generally relates to a mechanical device and particularly relates to a magnetic button phone case.

2. Description of Related Art

A phone case is an outer covering built from a ruggedized material to house a mobile phone. The phone case protects a phone body from deformation or damage due to dropping of phone from a certain height or friction against a hard surface.

One of the prior arts discloses a magnetic holder for cell phones comprising a cup formed of a ferromagnetic material or the like within which a magnet is supported. The rear surface of the cup includes a double-sided adhesive pad to provide attachment of the cup to a vehicle dashboard surface or the like. The cup concentrates the force of the magnet along the frontal edges thereof. Although the magnetic holder has ability to stick on any surface but it possesses a significant drawback for deteriorating a display of the mobile phone. The magnetic holder also create interferences with the electromagnetic signal during a communication resulting in continuous deterioration of the data exchange.

Various other prior arts implements the magnet based holder for phone and other purposes but in case of mobile phones and tablets, the usage is limited due to creation of persistent magnetic interference with the electromagnetic signals used for wireless data sharing and communication in mobile devices.

In the view of the foregoing, there is a need for a mobile phone case with efficient portability and adherence abilities and avoidance of any hindrance of deterioration of signals as well as mobile phone features.

The above mentioned shortcomings, disadvantages and problems are addressed herein, as detailed below.

### SUMMARY OF THE INVENTION

The primary object of the embodiments herein is to provide magnetic mobile phone case with efficient adherence abilities. The adherence abilities of the mobile case facilitates fixing or fastening to any smooth or curved surface.

The various embodiments herein disclose a mobile phone holder with magnetic adherence enhancement comprises a ruggedized case, a primary magnetic strip and a mating magnetic strip. The ruggedized case comprises an adjustable chamber on an internal surface. The primary magnetic strip is adhered to a back surface of the mobile phone holder using an adhesive. The mating magnetic strip comprises a rear surface applied with an adhesive. The mating magnetic strip is fixed to a non-metallic surface. The primary magnetic strip is magnetically locked to the mating magnetic strip.

According to an embodiment herein, the primary magnetic strip comprise a set of magnetic buttons.

According to an embodiment herein, the primary magnetic strip independently sticks to the metallic surfaces.

According to an embodiment herein, the primary magnetic strip is magnetically locked to the mating magnetic strip further fastening to a non-metallic surface. The adhesive on the rear surface of the mating magnetic surface has weak adherence nature.

According to an embodiment herein, the adhesive on a rear surface of the primary magnetic strip has strong adherence in nature.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIGS. 1a and 1b illustrates a front and back view of the magnetic mobile phone case, according to an embodiment herein.

FIG. 1c illustrates a mating magnetic strip, according to an embodiment herein.

FIG. 2 illustrates a flashlight with magnetic plate, according to an embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

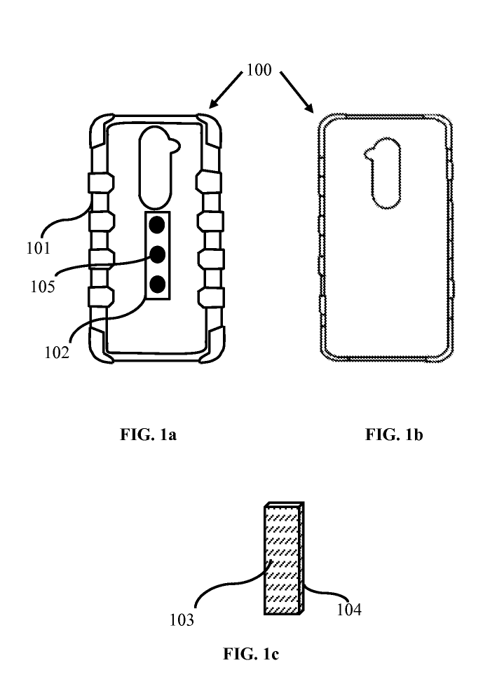

FIGS. 1a and 1b illustrates a front and back view of the magnetic mobile phone case, according to an embodiment herein. With respect to FIG. 1a, the magnetic mobile phone 100 case comprises a ruggedized case 101 with adaptability features as per user requirement. The adaptability features comprises a fixed dimension case and an adaptable dimension case. The fixed dimension case is built for a specific mobile device while the adaptable dimension case is extendible in nature and adapts to a range of mobile devices, Smartphones, phablet or tablets. The ruggedized case 101 is attached with a primary magnetic strip 102 comprising a plurality of magnetic buttons 105. The plurality of magnetic buttons 105 stick to any linear or curved metallic surface. The magnetic button 105 are two or three in numbers and a dimension of the magnetic button 105 is ⅛ inches (height)*2 inches (length)*¼ inches (width).

FIG. 1c illustrates a mating magnetic strip, according to an embodiment herein. With respect to FIG. 1c, the mating magnetic strip comprises a front magnetic surface 103 and a back surface 104 applied with a suitable adhesive. The mating magnetic strip is fixed to a plurality of non-metallic surface and thus allows the magnetic phone case to be fixed over a long range of surfaces.

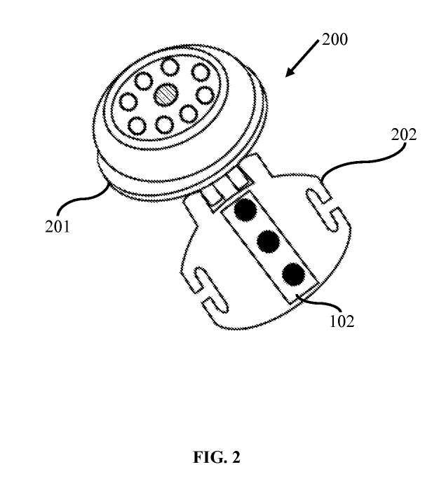

FIG. 2 illustrates a flashlight with magnetic plate, according to an embodiment herein. With respect to FIG. 2, the magnetic phone case is adapted to be used in a plurality of objects. As per an exemplary embodiment herein, it is used as a flap case 200 for a flashlight. The flap case has a housing chamber 201 for the flashlight and a bottom flap 202 surface fixed with the primary magnetic strip 102.

The magnetic mobile phone case has ability to stick to any surface, thus provides a hands-free ability to a class of works-men and professionals during performing a job or driving.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A mobile phone holder with magnetic adherence enhancement comprising:
a ruggedized case, wherein the ruggedized case comprises an adjustable chamber on an internal surface;
a primary magnetic strip, wherein the primary magnetic strip is adhered to a back surface of the mobile phone holder using an adhesive;
a mating magnetic strip, wherein the mating magnetic strip comprises a rear surface applied with an adhesive;
wherein, the mating magnetic strip is fixed to a non-metallic surface, wherein the primary magnetic strip is magnetically locked to the mating magnetic strip.

2. The mobile phone holder according to claim 1, wherein the primary magnetic strip comprises a set of magnetic buttons.

3. The mobile phone holder according to claim 1, wherein the primary magnetic strip independently sticks to the metallic surfaces.

4. The mobile phone holder according to claim 1, wherein the primary magnetic strip is magnetically locked to the mating magnetic strip further fastening to a non-metallic surface, wherein the adhesive on the rear surface of the mating magnetic surface has weak adherence nature.

5. The mobile phone holder according to claim 1, wherein the adhesive on a rear surface of the primary magnetic strip has strong adherence in nature.
